(19) United States
(12) Patent Application Publication
(10) Pub. No.: US 2008/0062892 A1
(43) Pub. Date: Mar. 13, 2008

(54) HIGH SPEED BUS PROTOCOL WITH PROGRAMMABLE SCHEDULER

(75) Inventors: David R. Dodgen, Palm Harbor, FL (US); Karl H. Becker, Riverview, FL (US); Jamal Haque, Tampa, FL (US); Keith A. Souders, Tampa, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/470,873

(22) Filed: Sep. 7, 2006

(51) Int. Cl. H04L 12/28

(52) U.S. Cl. 370/257

(57) ABSTRACT

A method of adapting the frequency of a protocol in a communication system is provided. The method includes changing a bus cycle used by communication nodes in a communication system based on cycle interval instructions.

### GOVERNMENT LICENSE RIGHTS

The U.S. Government may have certain rights in the present invention as provided for by the terms of Government Contract # F29601-03-C-0124 awarded by the United States Air Force.

### BACKGROUND

Communication between nodes in a communication system typically follows a predefined protocol so that the communication nodes know how to communicate with other. One of the functions of the protocols is to set out a frequency in which signals are to be communicated between nodes. An example of a common protocol is the IEEE 1394b (1394) protocol. The 1394 protocol uses a scheduler that is based on an 8 KHz frequency. That is, a marker within a communication frame that has frame boundaries is set to happen every 125 μSec (a 8 KHz frame rate). Each node in a communication system has a counter that is designed to count the 8 KHz frame rate to correctly identify marker in each communication frame. This frequency is commonly used for audio and video hardware. For example, one advantage of the 1394 protocol is that it uses a common serial bus that implements plug and play features. However, if the hardware is not designed to communicate at the 8 KHz frame rate, the advantages of the protocol cannot be used. Accordingly, systems that communicate at faster or slower frequencies have to implement costly custom protocols.

For the reasons stated above and for other reasons stated below which will become apparent to those skilled in the art upon reading and understanding the present specification, there is a need in the art for a way to use a common protocol at a different frequency than originally designed.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention. In one embodiment, a method of adapting the frequency of a protocol in a communication system is provided. The method includes changing a bus cycle used by communication nodes in a communication system based on cycle interval instructions.

### BRIEF DESCRIPTION OF THE DRAWINGS

The present invention can be more easily understood and further advantages and uses thereof more readily apparent, when considered in view of the detailed description and the following figures in which:

FIG. 1 is a communication system of one embodiment of the present invention;

FIG. 2 is a block diagram of a partial communication system of one embodiment of the present invention;

FIG. 3 is a flow diagram illustrating one method of one embodiment of the present invention; and

FIG. 4 is a graph of a timeline illustrating a change in communication frequency of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

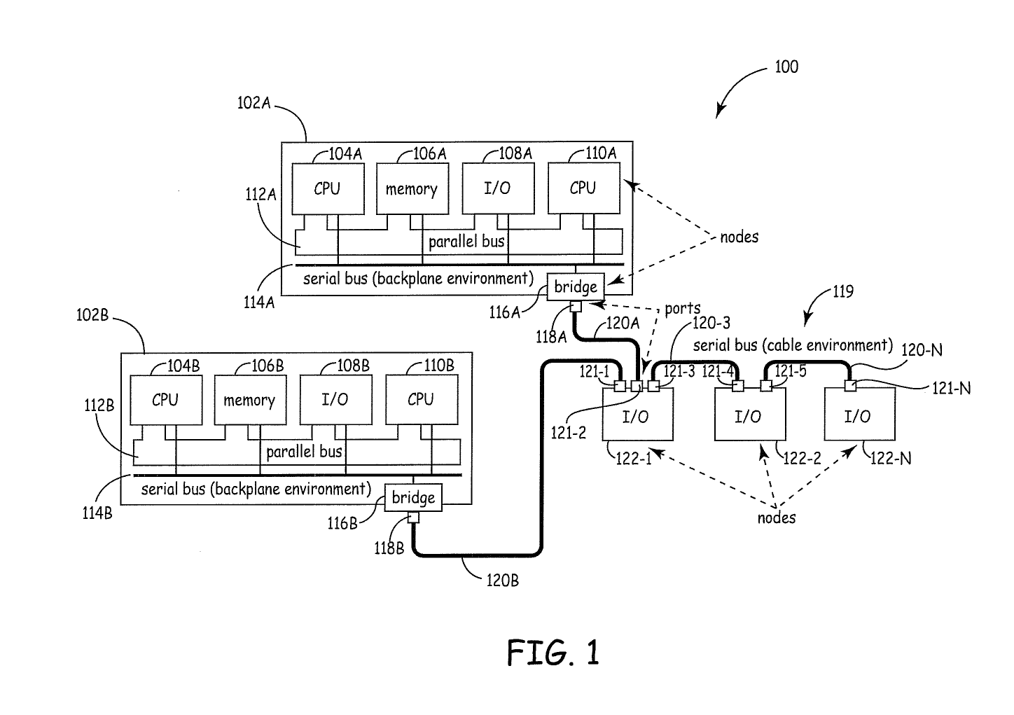

Embodiments of the present invention provide a system to modify or adapt the frequency used in a protocol. In one embodiment, this is accomplished by changing the bus cycle in each communication node in a communication system. Referring to FIG. 1, an example of a communication system 100 of one embodiment is illustrated. This communication system 100 includes a first system 102A, a second system 102B and a serial bus system 119. The first and second systems 102A and 102B includes CPUs 104A, 110A, 104B and 110B, memories 106A and 106B and I/Os 108A and 108B respectfully. Each of the aforementioned devices is coupled to a respective parallel bus 112A and 112B and a respective serial bus 114A and 114b.

As illustrated, the respective serial buses 114A and 114B are coupled to the serial bus system 119 via respective bridges 116A and 116B, ports 118A and 118B and serial buses 120A and 120B. The serial bus system 119 includes a plurality of I/O nodes 122 (1-N) and ports 121 (1-N). The nodes 122 (1-N) are in communication with each other by serial buses 120−3 and 120-N. It will be understood that the number of serial bus systems 119 as well as the number of first and second systems 102A and 102B in a communication system 100 can vary and the present invention is not limited to a specific number of systems in a communication system 100. Moreover, the number of elements in each system 119, 102A and 102B can vary. In embodiments of the present invention a node is designated as a cycle master node. The cycle master node can be any node in the communication system or may be constrained to specific nodes by the system architect. For example, the cycle master node could be any of nodes 122 (1-N) or the bridge node 116A or even CPU node 110A. Accordingly, the present invention is not limited to a specific node designated as the cycle master node. Moreover, in one embodiment the communication system is bridged across multiple dissimilar bus protocols linking the multiple communication nodes into a synchronized system.

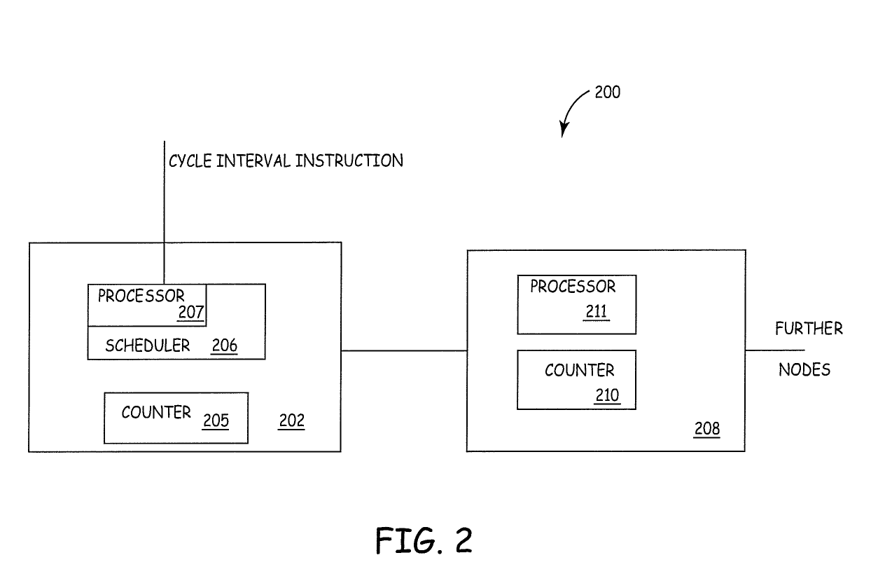

Referring to FIG. 2, a block diagram of a partial communication system 200 including a cycle master node 202 and another node 208 is illustrated. As illustrated the cycle master node 202 includes a scheduler 206 and a counter 205. The scheduler 206 includes a scheduler processor 207. The scheduler processor 207 processes cycle interval instructions received to generate a signal including a desired bus cycle for the communication system 200. The bus cycle defines the frequency for communication in the communication system 200. The bus cycle is then communicated to the other node 208 for implementation. In particular, a node processor 211 in each of the other nodes adjusts an associated counter 210 to the bus cycle. The counter 210 will then count frame rates based on the bus cycle. In one embodiment, the counter 210 in the other node 208 implements a programmable rollover count to set the bus cycle. Further in one embodiment, a maintenance type packet is used to program the counter 210 in each node 208.

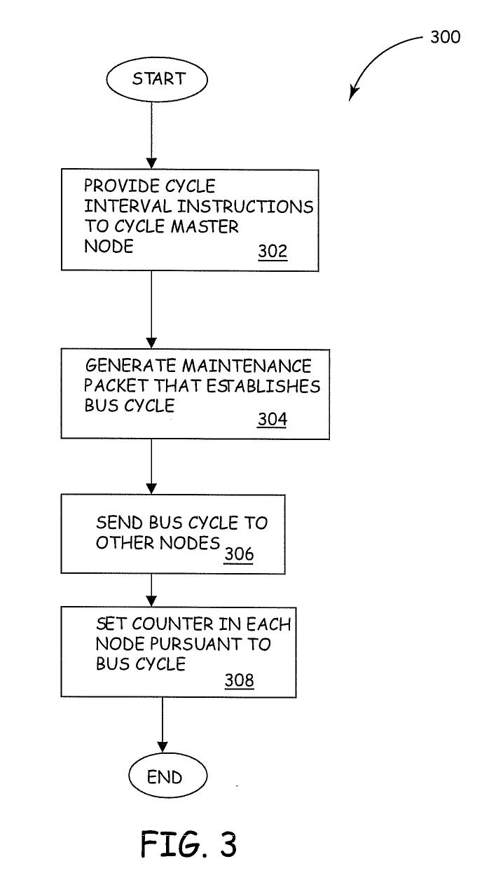

In FIG. 3 a flow diagram illustrating an example of one method of implementing the present invention is provided. As illustrated, cycle interval instructions to a cycle master node (302). In this embodiment, the cycle master node generates a maintenance packet that establishes the bus cycle based on the interval instructions (304). The maintenance packet (or maintenance type packet) including the bus cycle is then sent to other nodes (306). The initial maintenance packet is sent out at the default frame rate that would be set by a system clock so that the other nodes correctly time the receipt of the maintenance packet. Once the maintenance packet including the new bus cycle is received by a node, the counter in the node is adjusted to the new bus cycle (308). Moreover, after the cycle master sends out the maintenance packet with the new bus cycle, the cycle master adjusts its clock to the new bus cycle. Thereafter the communication system operates at a frequency set out by the bus cycle in the maintenance packet.

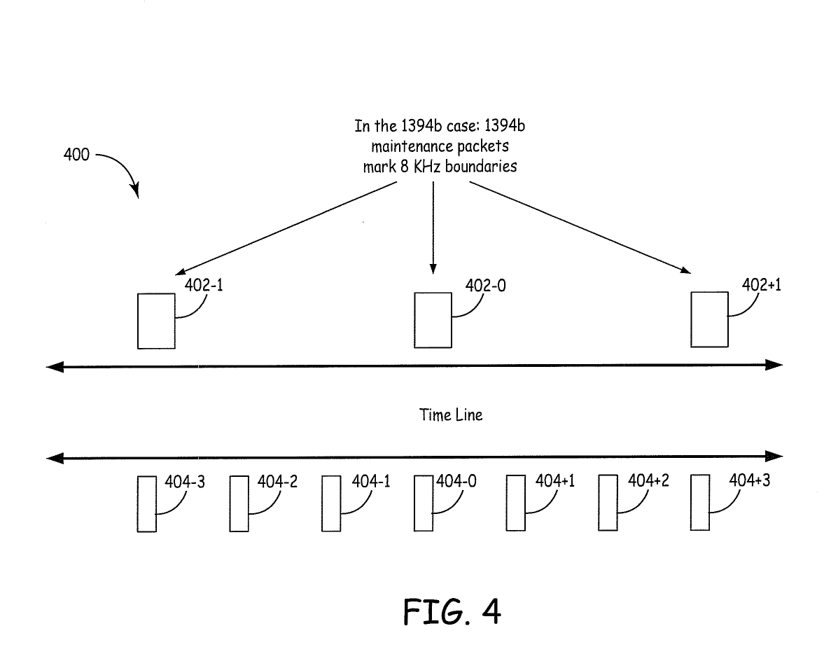

Referring to FIG. 4, a table 400 illustrating a time line of maintenance packets is illustrated. In this example, maintenance packets 402−1, 402−0 and 402+1 occur at 8 KHz boundaries. Using the 1394 protocol as an example, maintenance packets 404−3, 404−2, 404−1, 404−0, 404+1, 404+2 and 404+3 occur at a different selected frequency that is programmed into counters in each node a described above. As illustrated, in this example, maintenance packets 404−3, 404−2, 404−1, 404−0, 404+1, 404+2 and 404+3 occur at a faster frequency than the 8 KHz frequency. In other embodiments, the frequency in which the maintenance packets occur would be slower than the 8 KHz. Although, the time line uses a frequency rate of the example 1394 protocol as a comparison, it will be understood in the art that any variant of the 1394 protocol or any other protocol operating at a different frequency could be modified pursuant to the embodiments of the present invention.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of adapting the frequency of a protocol in a communication system, the method comprising:
changing a bus cycle used by communication nodes in a communication system based on cycle interval instructions.

2. The method of claim 1, wherein changing the bus cycle in each node further comprises:
programming a counter in each communication node to the bus cycle.

3. The method of claim 1, further comprising:
instructing a cycle master communication node to change the bus cycle;
generating a maintenance packet including the bus cycle; and
passing the maintenance packet to each communication node in each communication system.

4. The method of claim 3, further comprising
programming each counter based on the bus cycle in the maintenance packet.

5. The method of claim 1, wherein the bus cycle increases the frequency of communications in the communication system.

6. The method of claim 1, wherein the bus cycle decreases the communications in the communication system.

7. A method of adapting a communication protocol between communication nodes, the method comprising:
processing cycle interval instructions at a cycle master node;
generating a maintenance packet including a bus cycle based on the cycle interval instructions;
sending the maintenance packet to at least one other communication node; and
setting the counter on each of the at least one other communication node based on the bus cycle in the maintenance packet.

8. The method of claim 7, further comprising:
setting a counter of the cycle master node based on the bus cycle.

9. The method of claim 7, wherein setting the counter on each of the at least one communication node further comprises:
programming each counter to conduct a rollover count based on the bus cycle.

10. The method of claim 7, further comprising:
increasing the time interval between maintenance packets based on the bus cycle.

11. The method of claim 7, further comprising:
decreasing the time interval between maintenance packets based on the bus cycle.

12. A communication system comprising:
a plurality of communication nodes, each node having a programmable counter adapted to count the time interval between the receipt of maintenance packets; and
a cycle master node adapted to process instructions regarding a bus cycle of the communication system, the cycle master node further adapted to pass the bus cycle to the plurality of communication nodes, wherein the programmable counter in each communication node is adjusted to the bus cycle.

13. The communication system of claim 12, further comprising:
a serial bus coupled between the plurality of communication nodes and the cycle master node.

14. The communication system of claim 12, further comprising:
at least one bridge adapted to couple a first system of the communication system to a second system of the communication system.

15. The communication system of claim 12, further comprising:
at least one port at each node to couple a communication link between communication nodes.

16. The communication system of claim 12, wherein the bus cycle increases the frequency of communications in the communication system.

17. The communication system of claim 12, wherein the bus cycle decreases the frequency of the communications in the communication system.

18. The communication system of claim 12, wherein the communications system is bridged across multiple dissimilar bus protocols linking the plurality of communications nodes into a synchronized system.
